(19) United States
(12) Patent Application Publication
(10) Pub. No.: US 2013/0147293 A1
(43) Pub. Date: Jun. 13, 2013

(54) MOTOR

(71) Applicant: Honda Motor Co., Ltd., Tokyo (JP)

(72) Inventor: Manabu SAKURADA, Wako (JP)

(73) Assignee: HONDA MOTOR CO., LTD., Tokyo (JP)

(21) Appl. No.: 13/693,044

(22) Filed: Dec. 4, 2012

(30) Foreign Application Priority Data
Dec. 9, 2011 (JP) 2011-270004

(51) Int. Cl. H02K 5/22

(52) U.S. Cl. CPC H02K 5/225
USPC 310/71

(57) ABSTRACT

A motor includes a motor housing, a terminal holding member, a conducting terminal, a seal member, and a projection. The terminal holding member has a terminal mount hole through which an interior of the motor housing communicates with an exterior of the motor housing. The conducting terminal includes a first end, a second end, and an insertion portion. The first end is connected to a conductor wire of a stator inside the motor housing. The second end is connected to an external electric supply line outside the motor housing. The seal member is provided between the insertion portion of the conducting terminal and an inner peripheral surface defining the terminal mount hole. The projection is provided on the terminal holding member to engage with the conducting terminal to restrict coming-off of the conducting terminal toward the exterior of the motor housing.

### CROSS-REFERENCE TO RELATED APPLICATIONS

The present application claims priority under 35 U.S.C. §119 to Japanese Patent Application No. 2011-270004, filed Dec. 9, 2011, entitled “Motor.” The contents of this application are incorporated herein by reference in their entirety.

### BACKGROUND OF THE INVENTION

1. Field of the Invention

The present disclosure relates to a motor.

2. Discussion of the Background

One known motor of this type is configured in such a way that a terminal holding member made of an insulating material is mounted on part of the wall of a motor housing, and the conductor wires of the stator inside the motor housing are connected to electric supply lines outside the motor housing via conducting terminals held on the terminal holding member (see, for example, Japanese Unexamined Patent Application Publication No. 2011-160619).

In the motor described in Japanese Unexamined Patent Application Publication No. 2011-160619, metal conducting terminals are integrated with the terminal holding member, made of an insulating resin, by insert molding, and the terminal holding member is integrally mounted on part of the wall of the motor housing by bolts or the like.

### SUMMARY OF THE INVENTION

According to one aspect of the present invention, a motor includes a motor housing, a terminal holding member, a conducting terminal, a seal member, and a projection. The motor housing is to accommodate a stator on which a conductor wire is wound. The terminal holding member is made of an insulating material and is mounted in the motor housing. The terminal holding member has a terminal mount hole through which an interior of the motor housing communicates with an exterior of the motor housing. The conducting terminal extends through the terminal mount hole and includes a first end, a second end, and an insertion portion. The first end is connected to the conductor wire of the stator inside the motor housing. The second end is connected to an external electric supply line outside the motor housing. The insertion portion extends through the terminal mount hole and connects the first end and the second end. The seal member is provided between the insertion portion of the conducting terminal and an inner peripheral surface defining the terminal mount hole. The projection is provided on the terminal holding member to engage with the conducting terminal to restrict coming-off of the conducting terminal toward the exterior of the motor housing.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a perspective view of a motor according to one exemplary embodiment of the disclosure.

FIG. 2 is a cross-sectional view of the motor according to the embodiment of the disclosure along line II-II in FIG. 1.

FIG. 3 is a cross-sectional view of a terminal holding member on which conducting terminals according to the embodiment of the disclosure are mounted.

FIG. 4 is a perspective view of the terminal holding member according to the embodiment of the disclosure.

FIG. 5 is a bottom view of the terminal holding member according to the embodiment of the disclosure.

FIG. 6 is a perspective view of the conducting terminal according to the embodiment of the disclosure.

FIG. 7 is a side view of the conducting terminal according to the embodiment of the disclosure.

FIG. 8 is a perspective view showing the terminal holding member according to the embodiment of the disclosure from obliquely below.

FIG. 9A is a diagram showing the distribution of stress at a projection according to a comparative example, and FIG. 9B is a diagram showing the distribution of stress at a projection according to the embodiment of the disclosure.

FIG. 10A is a diagram showing the distribution of stress at the peripheral portion of a through hole according to a comparative example, and FIG. 10B is a diagram showing the distribution of stress at the peripheral portion of a through hole according to the embodiment of the disclosure.

FIG. 11 is a cross-sectional view of the motor according to the embodiment of the disclosure along line XI-XI in FIG. 2.

FIGS. 12A to 12E are cross-sectional views sequentially illustrating a step-by-step scheme of mounting the conducting terminals according to the embodiment of the disclosure.

FIG. 13 is a cross-sectional view showing a conducting terminal and a terminal holding member according to another exemplary embodiment of the disclosure.

### DESCRIPTION OF THE EMBODIMENTS

The embodiments will now be described with reference to the accompanying drawings, wherein like reference numerals designate corresponding or identical elements throughout the various drawings.

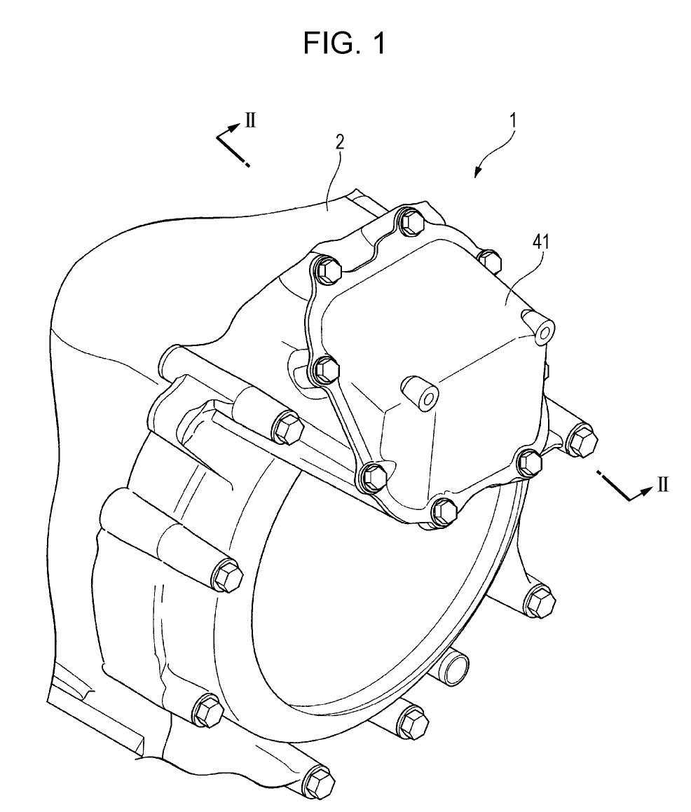

An exemplary embodiment of the disclosure will be described below with reference to FIGS. 1 to 11, and FIGS. 12A to 12E.

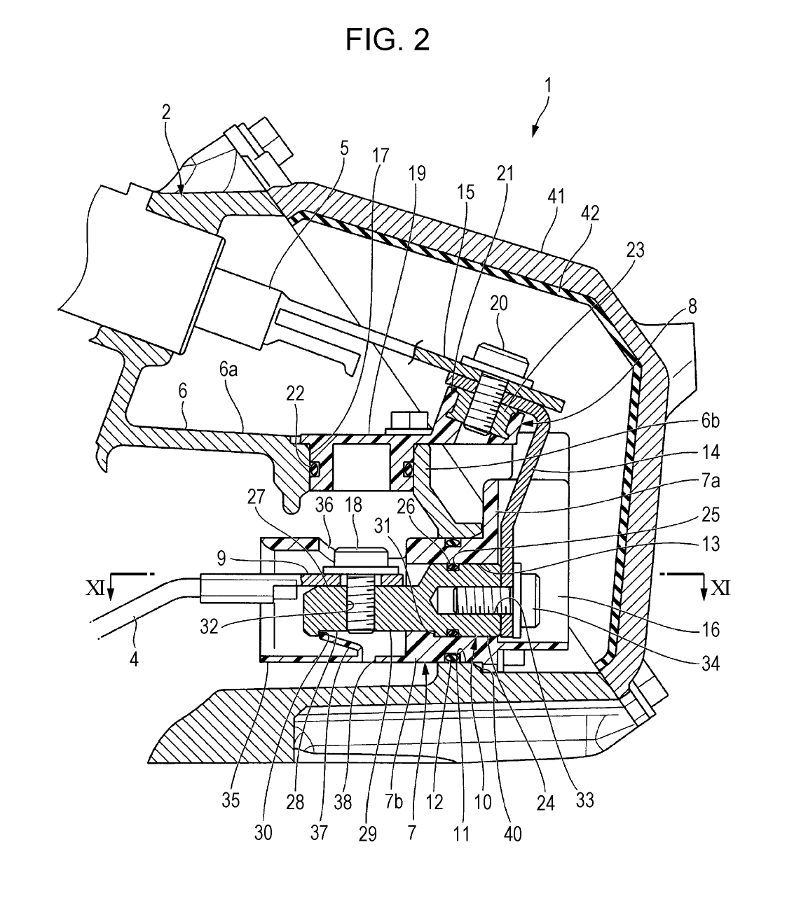

FIG. 1 is a perspective view showing the exterior of a motor 1 according to the embodiment, and FIG. 2 is a cross-sectional view corresponding to a cross-sectional portion II-II in FIG. 1. In the following description, the side that is equivalent to the upper side in FIG. 1 is called “up”, and the opposite side is called “down” unless otherwise specified.

The motor 1 according to the embodiment is used as a drive source for a hybrid vehicle or an electric vehicle. The motor 1 includes a motor housing 2 made of a metal material, such as an aluminum alloy, an unillustrated annular stator securely mounted in the motor housing 2, and an unillustrated rotor rotatably disposed inward of the stator. Three-phase conductor wires 4 of a U phase, V phase and W phase are wound around the stator. The ends of the conductor wires 4 of the individual phases are led out of the stator, and are connected to electric supply lines 5 of the respective phases, which are led in from outside the motor housing 2, at an upper region of an axial end portion of the motor housing 2.

As shown in FIG. 2, a terminal mount portion 6 which has a substantially flat upper wall 6a and an end wall 6b provided consecutively to the upper wall 6a is provided on the upper portion of one axial end side of the motor housing 2. A first terminal holding member 7 and a second terminal holding member 8, each made of an insulating resin material, are respectively mounted on the end wall 6b and the upper wall 6a of the terminal mount portion 6. Three metal conducting terminals 10 having one ends respectively connected with terminals 9 (hereinafter referred to as “coil terminals 9”) of the conductor wires 4 of the individual phases on the stator side are held on the first terminal holding member 7.

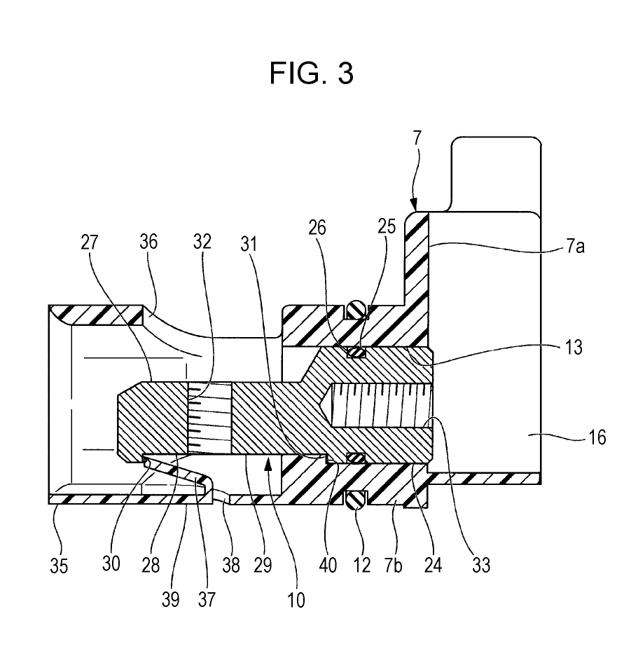

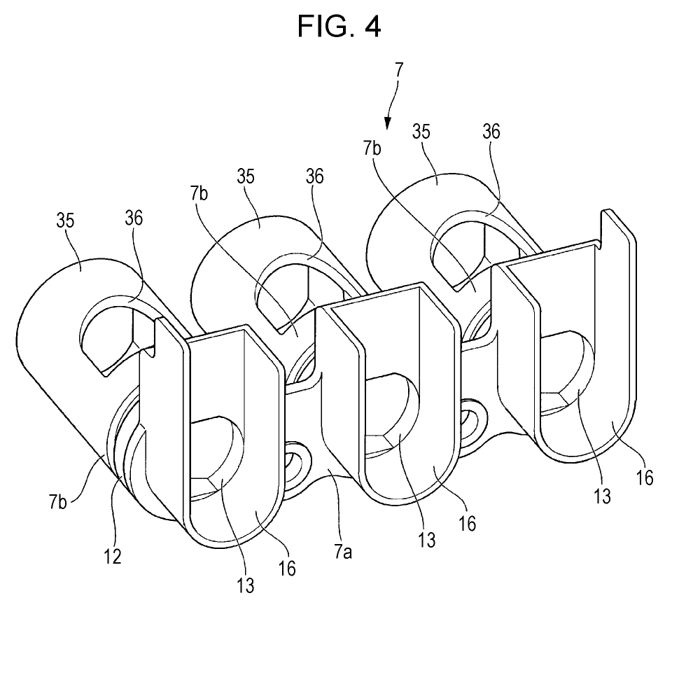

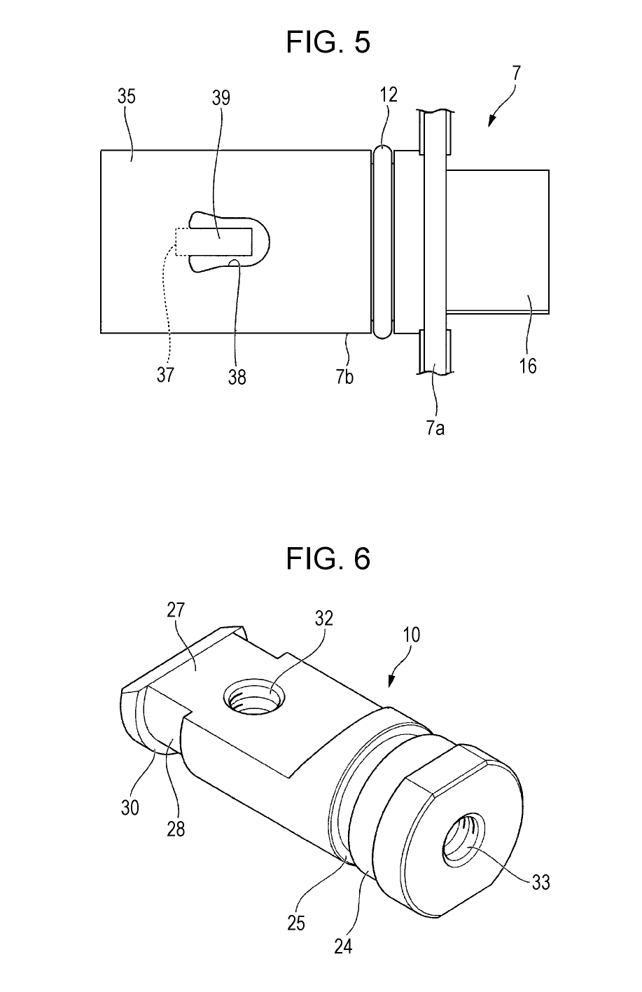

FIG. 3 is a diagram showing the first terminal holding member 7 having the conducting terminals 10 held thereon, and FIGS. 4 and 5 are diagrams showing the single first terminal holding member 7.

As shown in those diagrams, the first terminal holding member 7 includes a base wall 7a to be placed over and mounted on the end wall 6b from outside the motor housing 2, and three substantially cylindrical boss portions 7b in which the respective conducting terminals 10 are to be inserted. The three boss portions 7b are protrusively provided in parallel at equal intervals.

Three through holes 11 are formed in the end wall 6b of the terminal mount portion 6 in association with the boss portions 7b of the first terminal holding member 7, so that the boss portions 7b of the first terminal holding member 7 are inserted in the respective through holes 11. With the three boss portions 7b inserted in the respective through holes 11, the base wall 7a of the first terminal holding member 7 is fastened to the end wall 6b by bolts. Seal rings 12 are interposed between the individual boss portions 7b and the respective through holes 11 to seal therebetween.

The boss portion 7b to be inserted in the respective through hole 11 of the terminal mount portion 6 is provided with a terminal mount hole 13 axially penetrating through the boss portion 7b, and the conducting terminal 10 is inserted in the respective terminal mount hole 13 as shown in FIG. 2. Each conducting terminal 10 inserted in the terminal mount hole 13 has a distal end disposed inside the motor housing 2 and connected with the coil terminal 9 of the respective phase, and has a proximal end disposed outside the motor housing 2 and connected with a bus bar 14 made by a conductive metal plate. Each bus bar 14 extends upward from the joint portion with the conducting terminal 10. The extending upper end side is connected to a terminal 15 of the electric supply line 5 of the respective phase (hereinafter referred to as “power supply terminal 15”) on the second terminal holding member 8.

As shown in FIG. 4, a substantially U-shaped partition wall 16 enclosing the surrounding of the joint portion of the proximal end of each conducting terminal 10 and the respective bus bar 14 is formed on the base wall 7a of the first terminal holding member 7 to electrically shield the joint portion and the bus bar 14 from the outside with the partition wall 16.

Three work holes 17 are provided side by side in parallel in the upper wall 6a of the terminal mount portion 6. The individual work holes 17 are positioned directly above the joint portions of the distal ends of the three conducting terminals 10 and the coil terminals 9, and are used in carrying out a fastening work with a tool when the coil terminals 9 are fastened by bolts 1.

Lids 19 to be inserted in the three work holes 17, screw receivers 21 in which bolts 20 connecting the upper ends of the bus bars 14 and the conducting terminals 10 are screwed are provided on the second terminal holding member 8. FIG. 2 shows seal rings 22 each interposed between the lid 19 and the work hole 17, and nuts 23 each buried in the screw receiver 21 of the second terminal holding member 8.

FIGS. 6 and 7 are diagrams showing the exterior shape of the conducting terminal 10.

As shown in FIGS. 2 and 3, and FIGS. 6 and 7, the conducting terminal 10 has a basic shape of a column, and has approximately one third of the axial region of the proximal end portion serving as a fitting portion 24, and an annular hold groove 25 formed around the fitting portion 24. A seal ring 26 (seal member) is mounted in the hold groove 25 to seal between the terminal mount hole 13 and the conducting terminal 10.

The upper portion of approximately two thirds of the axial distal end portion of the conducting terminal 10 (portion which becomes the upper side when the conducting terminal 10 is mounted on the motor housing 2 as shown in FIG. 2) is cut away horizontally to provide a flat joint surface 27. The coil terminal 9 is placed over and coupled to the joint surface 27. The cutaway of the joint surface 27 is set in such a way that the joint surface 27 comes to approximately two thirds of the height of the basic cylindrical shape of the conducting terminal 10.

A cutaway groove 28 having a set width is provided in the circumferential area near the distal end portion of the conducting terminal 10 (excluding the cutaway portion of the joint surface 27). Further, a horizontal cutaway surface 29 continual to the cutaway groove 28 is provided on the bottom surface of two third the region of the axial distal end portion of the conducting terminal 10. Those cutaway groove 28 and cutaway surface 29 form, at the lower region of the distal end portion of the conducting terminal 10, a first engagement wall 30, which relatively heaves downward from the front end portion of the cutaway groove 28, and a second engagement wall 31, which relatively heaves downward from the rear end portion of the cutaway surface 29.

In the diagrams, reference numeral “32” represents a screw hole in which a bolt 18 for coupling the coil terminal 9 is screwed is provided in the distal end region of the conducting terminal 10, and reference numeral “33” represents a screw hole in which a bolt 34 (see FIG. 2) for coupling the bus bar 14 is screwed is provided in the proximal end surface of the conducting terminal 10.

As shown in FIGS. 2 and 3, a substantially cylindrical extending wall 35 extending along the axial direction from the circumferential region of the portion where the terminal mount hole 13 is formed is provided on the distal end portion of each boss portion 7b of the first terminal holding member 7 (end portion which is disposed inward of the motor housing 2) to shield the circumferential region of the circumferential region of the joint portion of the conducting terminal 10 and the coil terminal 9. It is to be noted however that a work hole 36 (second through hole) is provided in that position of the extending wall 35 which lies directly above the joint portion of the conducting terminal 10 and the coil terminal 9. The work hole 36 is provided in the position which matches the work hole 17 in the upper wall 6a of the terminal mount portion 6, and the bolt 18 is fastened through both work holes 17, 36.

A projection 37 protruding into the cylinder of the extending wall 35 is protrusively provided on the lower region of the extending wall 35 of each boss portion 7b. This projection 37 is formed in a plate shape having a substantially constant width. The projection 37 protrudes upward by a predetermined height from a position directly overlying the joint portion of the conducting terminal 10 and the coil terminal 9, and is bent obliquely upward in the direction of extension of the extending wall 35.

The projection 37 is pressed and deformed by the corner of the distal-end side lower end of the conducting terminal 10 when the conducting terminal 10 is inserted in the terminal mount hole 13 to a predetermined depth or more, and its distal end portion abuts on the inner end face of the first engagement wall 30 when the distal end portion rides over the distal end portion of the conducting terminal 10 and is elastically restored. This restricts the displacement of the conducting terminal 10 in the coming-off direction.

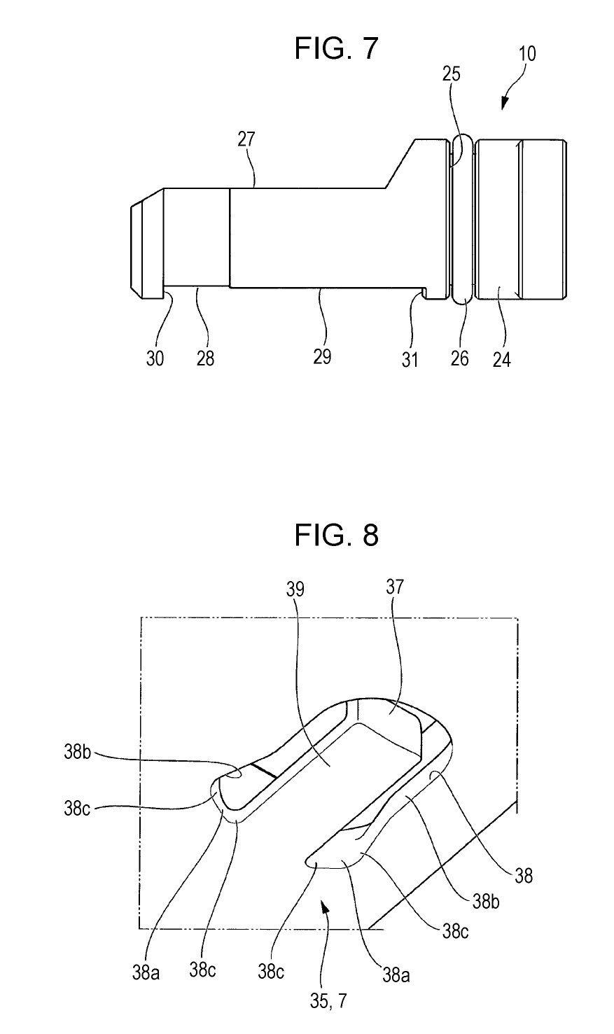

FIG. 8 is a diagram showing the vicinity of the rising portion of the projection 37 of the extending wall 35 from below.

As shown in FIGS. 5 and 8, a through hole 38 having a substantially square-bracket shape as seen from the front is formed around the rising portion of the projection 37 of the extending wall 35. The substantially square-bracket shape of the through hole 38 forms a strip-shaped deformation piece 39 (deformation allowing portion) extending from the distal end portion of the extending wall 35 toward the rising portion of the projection 37. When a load is applied to the projection 37, the deformation piece 39 is deformed together with the projection 37, thus dispersing the stress acting on the projection 37.

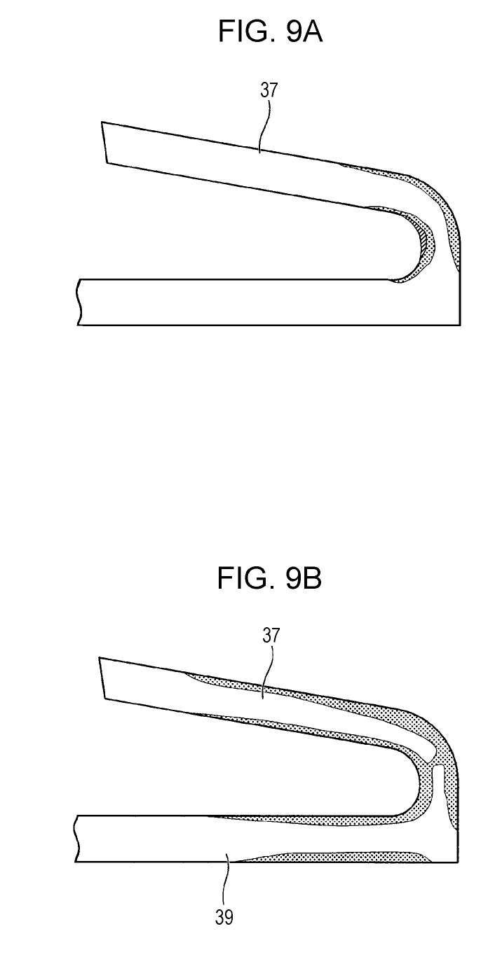

FIG. 9A is a diagram showing the distribution of stress on the peripheral portion of the projection 37 in a case where the through hole 38 is not provided in the extending wall 35, and FIG. 9B is a diagram showing the distribution of stress on the peripheral portion of the projection 37 in a case where the through hole 38 is provided in the extending wall 35.

As apparent from those diagrams, when the through hole 38 is not provided in the extending wall 35, stress is concentrated on the bent portion near the rising portion of the projection 37, whereas when the through hole 38 is provided in the extending wall 35, stress acting on the projection 37 can be dispersed in the entire circumferential portion of the projection 37.

Further, the shape of the square-bracket shaped opening of the through hole 38 provided in the extending wall 35 near the termination of the through hole 38 is not a simple opening having a constant width, but becomes broader toward the square-bracket shaped opening, and is formed in such a way that a termination portion 38a draws an arc about the vicinity of the rising portion of the projection 37, and is continual to a hole edges 38b along the axial direction of the extending wall 35 via an arc portion 38c with a large radius of curvature.

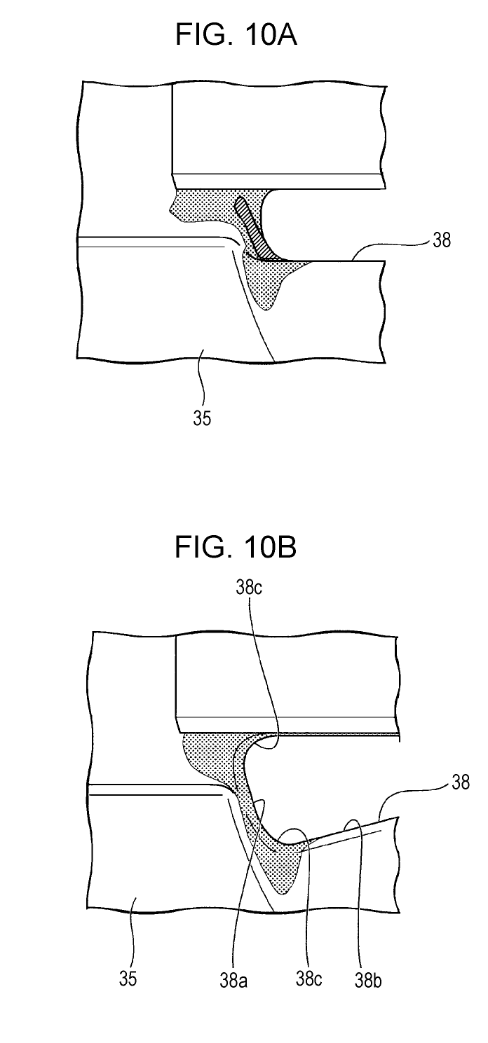

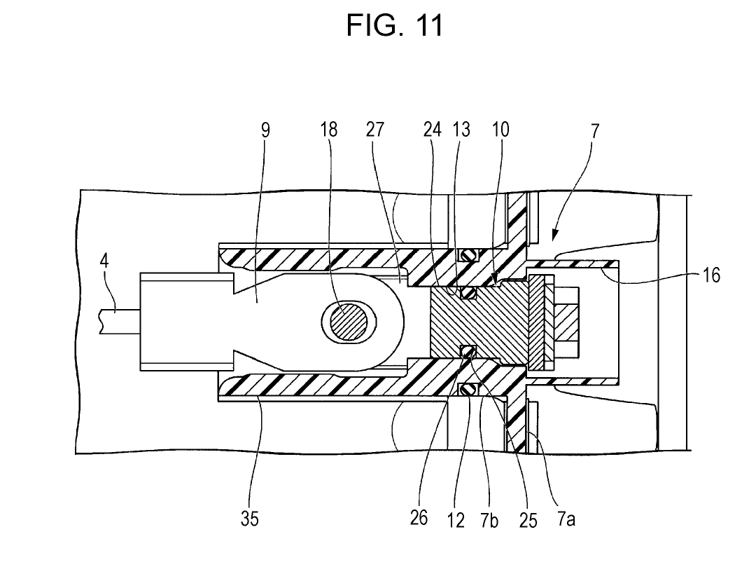

FIG. 10A is a diagram showing the distribution of stress when the shape of the square-bracket shaped opening of the through hole 38 near the termination thereof is a simple opening having a constant width, and FIG. 10B is a diagram showing the distribution of stress when the shape of the square-bracket shaped opening of the through hole 38 near the termination thereof is set in the aforementioned shape. FIG. 11 is a diagram for explaining the load that acts on the first terminal holding member 7 when the coil terminal 9 is fastened to the conducting terminal 10 by the bolt 18.

The stress which is assumed to act on the first terminal holding member 7 is the one originated from the torque which acts on the extending wall 35 from the coil terminal 9 when the coil terminal 9 is fastened by the bolt 18, as shown in FIG. 11.

When the shape of the square-bracket shaped opening of the through hole 38 near the termination thereof is a simple opening having a constant width as shown in FIG. 10A, stress is likely to be concentrated on near the termination portion, whereas when the shape of the square-bracket shaped opening of the through hole 38 near the termination thereof becomes broader toward the square-bracket shaped opening, and is formed in such a way that the termination portion 38a draws an arc about the vicinity of the rising portion of the projection 37 (vicinity of the fastening portion of the bolt 18) and is continual to the hole edges 38b along the axial direction of the extending wall 35 via the arc portion 38c with a large radius of curvature as shown in FIG. 10B, stress acting on the extending wall 35 can be dispersed in a wide range around the through hole 38.

As shown in FIGS. 2 and 3, an abutting portion 40 that heaves upward in the vicinity of the extending wall 35 side end of each boss portion 7b by a predetermined height is provided in the terminal mount hole 13 of the boss portion 7b. When the conducting terminal 10 is inserted in the terminal mount hole 13 to a predetermined depth, the abutting portion 40 abuts on the second engagement wall 31 of the conducting terminal 10 to restrict the displacement of the conducting terminal 10 in the insertion direction. The top surface of the abutting portion 40 is a horizontally flat surface.

In the case of the conducting terminal 10 and the first terminal holding member 7 according to the embodiment, as shown in FIG. 3, the first engagement wall 30 to be engaged with the projection 37 and the second engagement wall 31 to be engaged with the abutting portion 40 are set to the same height with the cutaway groove 28 and the cutaway surface 29 in between. When the conducting terminal 10 is attempted to be inserted straight in the terminal mount hole 13, therefore, the first engagement wall 30 on the distal end side of the conducting terminal 10 abuts on the abutting portion 40 in the terminal mount hole 13, inhibiting the conducting terminal 10 from being inserted further.

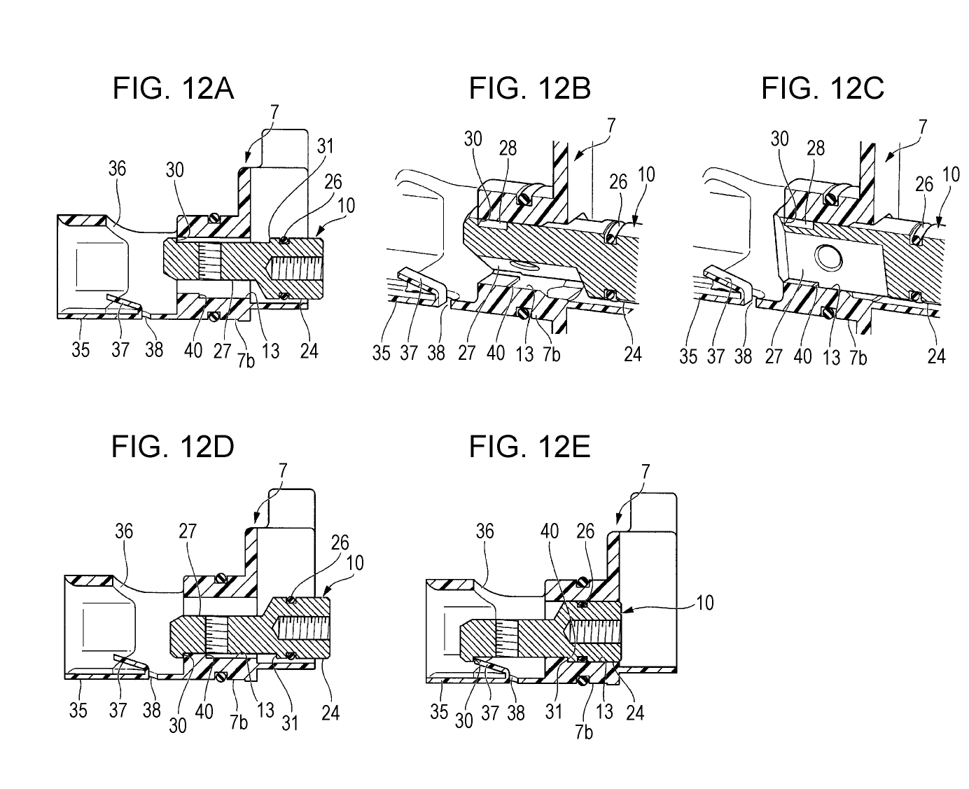

In case of mounting the conducting terminal 10 on the first terminal holding member 7, therefore, a scheme as shown in FIGS. 12A to 12E is adopted.

The following describes the mounting scheme shown in FIGS. 12A to 12E. It is to be noted that the seal ring 26 is mounted in the hold groove 25 of the conducting terminal 10 beforehand.

First, as shown in FIG. 12A, the conducting terminal 10 is inverted by approximately 180° with respect to the final mount state so that the first engagement wall 30 of the conducting terminal 10 comes on the upper side, and the distal end portion of the conducting terminal 10 in that state is inserted in the terminal mount hole 13 of the first terminal holding member 7. At this time, the outer arcuate surface of the first engagement wall 30 slides over the upper region of the terminal mount hole 13 where the abutting portion 40 is not present. In this state, the conducting terminal 10 is inserted until the first engagement wall 30 comes out of the terminal mount hole 13.

Next, when the first engagement wall 30 comes out of the terminal mount hole 13, the conducting terminal 10 is rotated by 180° to the final mount state as shown in FIGS. 12B, 12C and 12D. When the conducting terminal 10 is rotated to the final mount state this way, the first engagement wall 30 is positioned on the distal end side with respect to the abutting portion 40 while the first engagement wall 30 lies in the range of lapping the abutting portion 40 in the axial direction.

Then, the conducting terminal 10 is inserted further in the terminal mount hole 13 while keeping the final mount state. When the conducting terminal 10 is inserted further in the terminal mount hole 13 this way, the corner portion of the lower portion of the distal end of the conducting terminal 10 abuts on the projection 37 on the extending wall 35, deforming the projection 37. When the conducting terminal 10 is inserted to a predetermined position this way, the projection 37 rides over the arcuate surface of the first engagement wall 30 so that the distal end portion of the projection 37 abuts on the inner end face of the first engagement wall 30 and the second engagement wall 31 abuts on the abutting portion 40 in the terminal mount hole 13, as shown in FIG. 12E.

As a result, the displacement of the conducting terminal 10 in the coming-off direction and the insertion direction with respect to the terminal mount hole 13 is restricted by the projection 37 and the abutting portion 40.

The mounting of the conducting terminal 10 on the first terminal holding member 7 described above is carried out before the first terminal holding member 7 is mounted on the terminal mount portion 6 of the motor housing 2. After the first terminal holding member 7 with the conducting terminal 10 previously mounted thereon is mounted on the terminal mount portion 6 of the motor housing 2, each coil terminal 9 and the conducting terminal 10 are coupled together through the work holes 17, 36, after which the second terminal holding member 8 is mounted on the terminal mount portion 6, the lower end portion of the bus bar 14 is coupled to the conducting terminal 10, and the power supply terminal 15 is coupled to the upper end portion of the bus bar 14.

When every line connection is completed this way, a metal protection cover 41 covering around the bus bars 14, the line-connected portions, etc. is attached to the upper portion of the terminal mount portion 6 as shown in FIG. 2. An insulating rubber member 42 is secured to the inner surface of the protection cover 41 by baking. This rubber member 42 can enhance the insulation quality of the metal protection cover 41 to the bus bars 14, the line-connected portions, etc., thereby making it possible to design the protection cover 41 compact, and further suppress scattering of pieces of the protection cover 41 if broken.

According to the motor 1 according to the embodiment, as described above, the seal ring 26 seals between each terminal mount hole 13 of the first terminal holding member 7 and the respective conducting terminal 10, the projection 37 on the first terminal holding member 7 restricts coming-off of the conducting terminal 10 from the terminal mount hole 13, so that even when thermal stretching of the first terminal holding member 7 and the conducting terminal 10 which have different linear expansion coefficients occurs, it is possible to stably seal between the terminal mount hole 13 of the first terminal holding member 7 and the conducting terminal 10 always in a steady state.

Further, according to the embodiment, the abutting portion 40 provided in the terminal mount hole 13 restricts the displacement of the conducting terminal 10 in the insertion direction with respect to each terminal mount hole 13, an excessive displacement of the conducting terminal 10 in the insertion direction can be restricted, thus making it possible to hold the conducting terminal 10 in a steady state more stably.

In the motor 1 according to the embodiment, therefore, it is possible to always keep the steady sealing between each terminal mount hole 13 and the respective conducting terminal 10, thereby surely preventing the coolant from leaking outside the motor housing 2.

Further, in the motor 1 according to the embodiment, the surrounding region of the joint portion of each conducting terminal 10 and the coil terminal 9 is enclosed by the substantially cylindrical extending wall 35 of the first terminal holding member 7, and the projection 37 is protrusively provided on the lower region of the joint portion of the extending wall 35, so that the projection 37 can be set in the proper position on the first terminal holding member 7 while insulating the surrounding region of the joint portion of the conducting terminal 10.

Furthermore, in the motor 1 according to the embodiment, the substantially square-bracket shaped through hole 38 is provided around the rising portion of the projection 37 of the extending wall 35 on the first terminal holding member 7, and the deformation piece 39 continual to the projection 37 is formed by the through hole 38, thus making it possible to reduce concentration of stress on the projection 37 caused by the deformation piece 39 and prevent the projection 37 from being deteriorated.

Moreover, the motor 1 can surely permit the coolant in the motor housing 2 which has flowed into the extending wall 35 to be discharged downward through the through hole 38 in the lower region of the extending wall 35. Therefore, the use of this configuration can overcome the problems which may occur due to the coolant staying at the extending wall 35 for a long period of time, such as deterioration of the joint portion of the conducting terminal 10 and the coil terminal 9, degrading of the coolant itself, and deficiency of the coolant at portions where the coolant is needed.

In addition, according to the embodiment, the work hole 36 is formed in the upper region of the substantially cylindrical extending wall 35, so that the workability of connecting the coil terminal 9 and the conducting terminal 10 can be improved while insulating the joint portion of the conducting terminal 10.

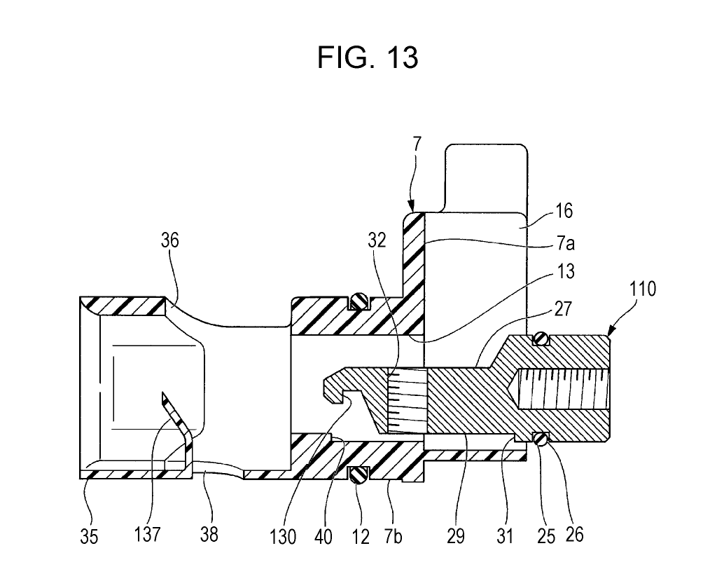

The disclosure is not limited to the foregoing embodiment, and may be modified in various other forms without departing from the scope of the disclosure. For example, the first engagement wall 30 and the second engagement wall 31 on the conducting terminal 10 are set to the same height according to the embodiment, so that the special mounting scheme as shown in FIGS. 12A to 12E is needed; however, when a first engagement wall 130 on the distal end side is set higher and a projection 137 is set higher accordingly according to another embodiment shown in FIG. 13, a conducting terminal 110 can be inserted in the respective terminal mount hole 13 while keeping the final mount state. To avoid the redundant description, same reference numerals are given to those portions in FIG. 13 which are the same as the corresponding portions of the foregoing embodiment.

The motor according to an aspect of the exemplary embodiment of the disclosure includes a stator on which a conductor wire is wound, a motor housing (e.g., motor housing 2 in the exemplary embodiment) accommodating the stator therein, a terminal holding member (e.g., first terminal holding member 7 in the exemplary embodiment) made of an insulating material and to be mounted in the motor housing, the terminal holding member having a terminal mount hole (e.g., terminal mount hole 13 in the exemplary embodiment) formed to communicate an interior and an exterior of the motor housing with each other, a conducting terminal (e.g., conducting terminal 10 in the exemplary embodiment) having one end connected to a conductor wire of the stator inside the motor housing, and other end connected to an external electric supply line outside the motor housing, the conducting terminal being inserted in the terminal mount hole along a predetermined insertion direction, a seal member (e.g., seal ring 26 in the exemplary embodiment) interposed between the terminal mount hole and an insertion portion of the conducting terminal, and a projection (e.g., projection 37 in the exemplary embodiment) provided on the terminal holding member to engage with the conducting terminal to restrict coming-off of the conducting terminal in a direction opposite to the insertion direction when the conducting terminal is inserted in the terminal mount hole.

According to the aspect of the embodiment, the seal member seals between the conducting terminal and the terminal mount hole of the terminal holding member, and the projection restricts coming-off of the conducting terminal from the terminal mount hole of the terminal holding member. This makes it possible to stably seal between the conducting terminal and the terminal holding member even upon occurrence of a temperature variation, thereby preventing the coolant from leaking from inside the motor housing.

In the motor according to the aspect of the embodiment, the terminal holding member is preferably provided with an abutting portion (e.g., abutting portion 40 in the exemplary embodiment) that abuts on the conducting terminal to restrict a displacement of the conducting terminal in the insertion direction when the conducting terminal is inserted in the terminal mount hole.

According to this configuration of the embodiment, the displacement of the conducting terminal in the insertion direction with respect to the terminal mount hole of the terminal holding member is restricted by the abutting portion, making it possible to stably seal between the conducting terminal and the terminal mount hole.

In the motor according to the aspect of the embodiment, the terminal holding member is preferably provided with an extending wall (e.g., extending wall 35 in the exemplary embodiment) that extends inward of the terminal mount hole in the motor housing, and covers at least a lower region of a joint portion of the conducting terminal and the conductor wire of the stator, and the projection is formed on the extending wall.

According to this configuration of the embodiment, at least the lower region of the joint portion of the conducting terminal and the conductor wire of the stator is shielded by the extending wall, and the extending wall is provided with the projection. This makes it possible to set the projection on the terminal holding member in the proper position while insulating the lower region of the joint portion of the conducting terminal on the stator side.

In the previously described motor of the embodiment, a through hole (e.g., through hole 38 in the exemplary embodiment) is preferably formed around a rising portion of the projection.

According to this configuration of the embodiment, the through hole is formed around the rising portion of the projection, so that deformation of the rising portion of the projection is facilitated by the through hole, suppressing stress acting on the projection and thus preventing the projection from being deteriorated.

Further, according to this configuration of the embodiment, the coolant which flows to the extending wall can surely be discharged below the extending wall through the through hole. This makes it possible to overcome the problems which may occur due to the coolant staying at the extending wall for a long period of time, such as deterioration of the joint portion of the conducting terminal and the terminal holding member, degrading of the coolant itself, and deficiency of the coolant.

In the previously described motor of the embodiment, the through hole is preferably formed in a substantially square-bracket shape surrounding the projection.

According to this configuration of the embodiment, the through hole is formed in a substantially square-bracket shape surrounding the projection, so that stress acting on the projection can be suppressed more effectively by the strip-shaped deformation allowing portion that is formed by the substantially square-bracket shaped through hole, thus preventing the projection from being deteriorated.

In the motor of the embodiment, the extending wall is preferably formed in a cylindrical shape covering the joint portion of the conducting terminal and the conductor wire of the stator, and a second through hole (e.g., work hole 36 in the exemplary embodiment) is preferably formed in an upper region of the extending wall which faces the through hole.

According to this configuration of the embodiment, the joint portion of the conducting terminal and the conductor wire of the stator is covered with the cylindrical extending wall made of an insulating material, and the second through hole is formed in the upper region of the extending wall, thus making it possible to improve the connection workability on the stator side of the conducting terminal while insulating the surrounding of the stator-side joint portion of the conducting terminal.

Obviously, numerous modifications and variations of the present invention are possible in light of the above teachings. It is therefore to be understood that within the scope of the appended claims, the invention may be practiced otherwise than as specifically described herein.

What is claimed is:

1. A motor comprising:
a motor housing to accommodate a stator on which a conductor wire is wound;
a terminal holding member made of an insulating material and mounted in the motor housing, the terminal holding member having a terminal mount hole through which an interior of the motor housing communicates with an exterior of the motor housing;
a conducting terminal comprising:
a first end connected to the conductor wire of the stator inside the motor housing;
a second end connected to an external electric supply line outside the motor housing; and
an insertion portion extending through the terminal mount hole and connecting the first end and the second end;
a seal member provided between the insertion portion of the conducting terminal and an inner peripheral surface defining the terminal mount hole; and
a projection provided on the terminal holding member to engage with the conducting terminal to restrict coming-off of the conducting terminal toward the exterior of the motor housing.

2. The motor according to claim 1, wherein the terminal holding member includes an abutting portion to abut on the conducting terminal to restrict a displacement of the conducting terminal toward the interior of the motor housing.

3. The motor according to claim 1,
wherein the terminal holding member includes an extending wall extending toward the interior of the motor housing to cover at least a lower region of a joint portion of the conducting terminal and the conductor wire of the stator, and
wherein the projection is provided on the extending wall.

4. The motor according to claim 3, wherein the extending wall includes a first through hole provided around a rising portion of the projection.

5. The motor according to claim 4, wherein the first through hole has a substantially square bracket shape and surrounds the projection.

6. The motor according to claim 4,
wherein the extending wall has a cylindrical shape and covers the joint portion of the conducting terminal, and
wherein the extending wall includes a second through hole provided in an upper region of the extending wall, the second through hole being provided opposite to the first through hole with respect to the conducting terminal.

7. The motor according to claim 3, wherein the projection extends from the extending wall toward the conducting terminal to engage with the conducting terminal.

8. The motor according to claim 2, wherein the abutting portion is provided in the terminal mount hole.

9. The motor according to claim 1, further comprising:
a protection cover provided outside of the motor housing and connected to the motor housing to define a protection space together with the motor housing, the second end of the conducting terminal being provided in the protection space,
wherein the projection is provided to engage with the conducting terminal to restrict coming-off of the conducting terminal toward the protection space.
